(19) United States
(12) Patent Application Publication
(10) Pub. No.: US 2007/0165898 A1
(43) Pub. Date: Jul. 19, 2007

(54) Acoustic head structure of a microphone

(76) Inventors: Chin-Ching Huang, Taichung City (TW); Min-Te Tu, Tanzih Township (TW); Jiung-Yue Tien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/391,427

(22) Filed: Mar. 29, 2006

(30) Foreign Application Priority Data
Jan. 17, 2006 (TW) 95101754

(51) Int. Cl. H04R 17/02

(52) U.S. Cl. 381/369

(57) ABSTRACT

An acoustic head structure for a microphone is disclosed. It comprises a substrate, a sound-processing unit and an upper cap. The upper cap has a plurality of acoustic holes that are through-holes arranged about the upper lid. The position and shape of the acoustic holes can prevent foreign matter like dust from falling into the acoustic head structure.

### RELATED APPLICATIONS

The present application is based on, and claims priority from, Taiwan Application Serial Number 95101754, filed Jan. 17, 2006, the disclosure of which is hereby incorporated by reference herein in its entirety.

### BACKGROUND

1. Field of Invention

The present invention relates generally to an acoustic head structure of a microphone, and more particularly to an acoustic head structure of a microphone that prevents the acoustic head from receiving foreign matter.

2. Description of Related Art

A microphone is used to capture sound and is frequently seen in business and entertainment fields. The acoustic head of a microphone comprises electronic units which can not only collect but process sounds. Acoustic holes are set in the exterior cap, which composes the acoustic head, in order to collect sound. Based on general usage habits, the acoustic head of the microphone is usually set beneath a user's mouth; therefore, the acoustic holes are arranged on the acoustic head in order to better collect sounds.

Reference is made to FIG. 1, which illustrates an acoustic head structure of a microphone. The acoustic head 100 comprises the substrate 110, sound-processing unit 120 and upper cap 130.

Among these devices, the substrate 110 contains a circuit board and a sound-processing unit 120 containing a sound sensor 121, signal amplifier 122 and electronic unit 123, wherein the acoustic hole 131 is set on the top of the upper cap 130.

In this known acoustic head structure, the circuit board of the substrate 110 is used to seat the sound-processing unit 120, wherein the sound sensor 121 is set in the center of the substrate. Alongside the substrate are the signal amplifier 122 and the electronic unit 123, and the electronic unit 123 can provide resistance or capacitance as necessary. The acoustic holes arranged on the top of the upper cap 130 are applied to collect the sound.

Because the acoustic holes 131 face upward, foreign matter like grit, rain, dust and saliva can pollute the interior of the acoustic head 100 and damage the sound-processing unit 120.

The problems as mentioned about the current technology can decrease, even disable the acoustic head's performance, diminishing the durability of the microphone and increasing maintenance cost. However, these problems can be reduced or eliminated by the present invention.

### SUMMARY

In order to not only solve the aforementioned and other problems but also achieve the technical benefits which this invention advocates, this invention provides an acoustic head structure for a microphone that prevents foreign matter from entering into the microphone.

It is therefore an objective of the present invention to provide an acoustic head structure of a microphone, of which acoustic holes are set about the flank of the acoustic head in order to prevent foreign matter from entering the interior of the acoustic head.

It is another objective of the present invention to provide an acoustic head structure of a microphone which collects sound better. Because the acoustic holes are set about the flank of the acoustic head, the resulting shape of the acoustic holes can boost the effect of sound collection.

It is still another objective of the present invention to provide an acoustic hole which can collect sound well and furthermore is arranged to decrease foreign matter intrusion into the acoustic head so that the acoustic head structure of a microphone can be more durable.

According to the aforementioned objectives of the present invention, a new acoustic head structure of a microphone is provided. In one embodiment of the present invention, the acoustic holes are cylindrical and parallel to the microphone base and are set about the flank of the upper cap of the acoustic head. This kind of arrangement of the hole can keep foreign matter from falling down from above the microphone and into the interior of the acoustic head.

In another embodiment of the present invention, the acoustic holes are shaped as horns. This kind of profile has more surface area by which to collect sound and is shaped so as to keep dust, dew and other small foreign matter from entering the acoustic head.

In yet another embodiment of the present invention, the position of the acoustic holes can be flanked about the same half of the upper cap of the acoustic head. Therefore, the acoustic holes are beneath the microphone when the microphone is set obliquely; in this way, foreign matter is kept from entering effectively.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 illustrates a prior-art profile of the acoustic head of a microphone, wherein the acoustic hole is set on the top of the upper cap;

FIG. 2 illustrates a profile of the acoustic head structure of a preferred embodiment of the present invention, wherein the acoustic holes are horizontal and parallel to the head base;

FIG. 3 illustrates a profile of the acoustic head structure of a preferred embodiment of the present invention, wherein the profile of the acoustic holes is in the form of a horn;

FIG. 4 illustrates a profile of the acoustic head structure of a preferred embodiment of the present invention, wherein the acoustic holes are semi-conical;

FIG. 5 illustrates a profile of the acoustic head structure of a preferred embodiment of the present invention, wherein the acoustic holes are shaped as declining horns;

FIG. 6 illustrates a profile of the acoustic head structure of a preferred embodiment of the present invention, wherein the acoustic holes are shaped as declining cylinders;

FIG. 7 illustrates an enlarged profile of the acoustic head structure of a preferred embodiment of the present invention, wherein the top of the hole on one face aligns horizontally with the bottom of the hole on the opposite face;

FIG. 8 illustrates a top view of the upper cap of the acoustic head structure of a preferred embodiment of the present invention, wherein the acoustic holes are arranged symmetrically opposite to each other;

FIG. 9 illustrates a top view of the upper cap of the acoustic head structure of a preferred embodiment of the present invention, wherein the acoustic holes are arranged to one side; and

FIG. 10 illustrates a top view of the upper cap of the acoustic head structure of the preferred embodiment of the present invention, wherein the acoustic holes are rectangular and arranged to one side.

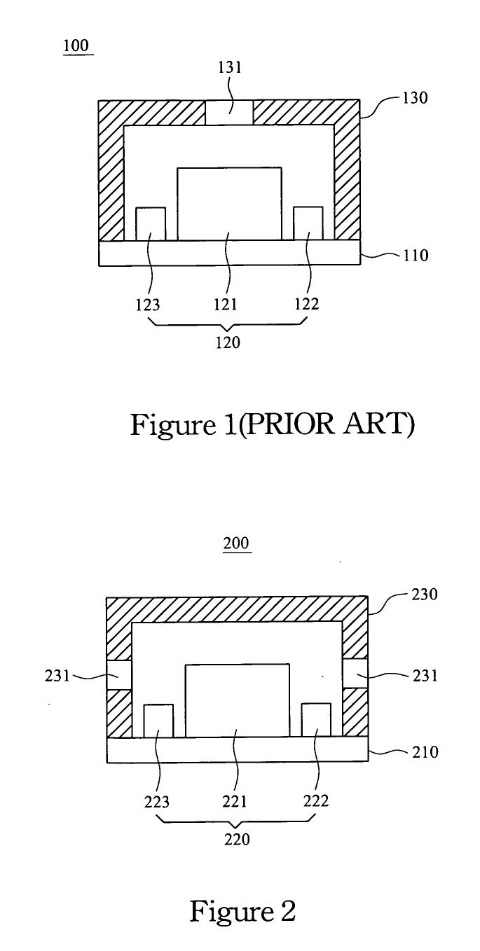

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

Reference is made to FIG. 2, which illustrates a profile of the acoustic head structure of a preferred embodiment of the present invention. An acoustic head 200 includes a substrate 210, a sound-processing unit 220 and an upper cap 230. The acoustic head is shaped into a rectangle or non-rectangle.

The substrate 210 includes a circuit board and a sound-processing unit 220, which includes a sound sensor 221, a signal amplifier 222 and an electronic component 223. In addition, acoustic holes 231 are set about the flank of the upper cap 230.

The circuit board of the substrate 210 is applied to seat the sound-processing unit. The sound sensor 221 is set on the substrate 210, and both the signal amplifier 222 and the electronic component 223 are set adjacent. Moreover, the electronic component 223 can provide resistance or capacitance, and the acoustic holes 231 set on the upper cap 230 are applied to receive sound.

The acoustic holes are located about the flank of the upper cap in order to effectively keep foreign matter from falling down into the interior of the acoustic head.

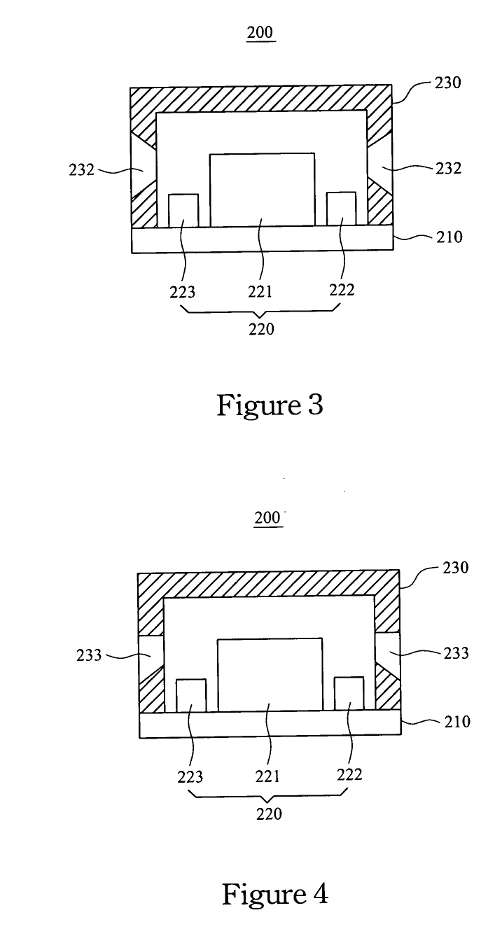

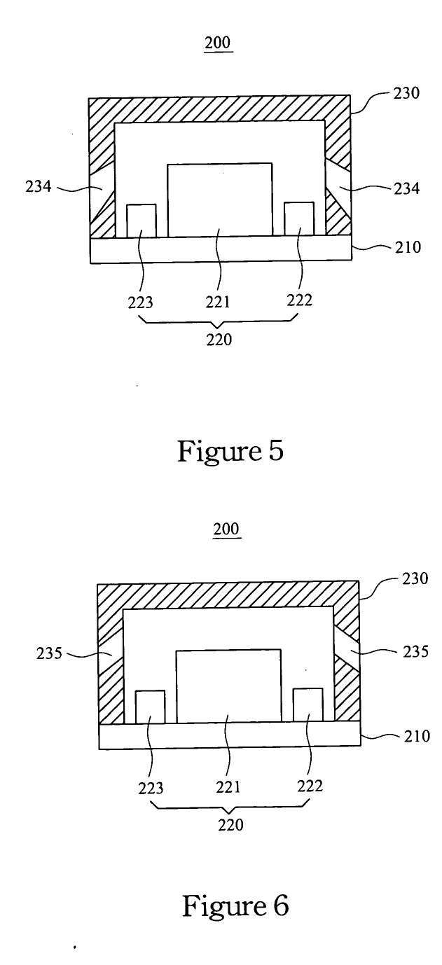

Reference is made to FIGS. 3 through 5, which illustrate profiles of the acoustic head structure of the preferred embodiment of the present invention. The profile of the acoustic hole 232 in the FIG. 3 is hornlike. The upper part of the profile of the acoustic hole 233 displayed in FIG. 4 is horizontal, and the lower part is shaped as a semi-oblique horn declining downward. The profile of the acoustic hole 234 displayed in FIG. 5 is shaped as a completely oblique horn declining downward.

The aforementioned shapes of the acoustic holes 232, 233 and 234 have larger surface areas than the acoustic hole 231 so that they better collect sound. Furthermore, the position of the opening on the inner wall of the upper cap 230 is identical to the acoustic hole 231, so it is not easy for the tiny foreign matter, like dust and dew, to enter.

Reference is made to FIG. 6, which illustrates a profile of the acoustic head structure of the preferred embodiment of the present invention. The profile of the acoustic hole is an oblique aperture which inclines downward so that it shelters the acoustic head 200 from foreign matter even better than the hornlike holes of acoustic heads 232, 233 and 234.

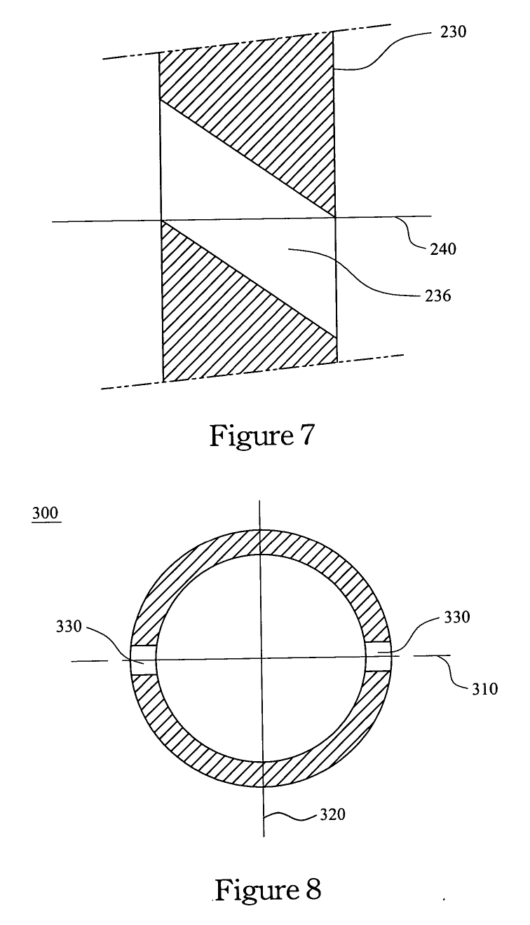

Reference is also made to FIGS. 6 through 7. Both the upper and lower surfaces of the acoustic hole 236 in the profile are located on the horizontal line 240 and are also parallel to each other. The profile of the acoustic hole 236 can effectively reduce the chance of foreign matter entering into the interior of acoustic head 200 directly. In addition, the acoustic waves can reflect to the interior of the acoustic head and be received by the sound sensor after reflecting from the upper part to the lower part.

The aforementioned acoustic head 200 in FIGS. 2-7 illustrate a preferred embodiment wherein the acoustic holes 231, 232, 233, 234, 235 and 236 are symmetrically set on opposite sides of the upper cap 230. Furthermore, there may be one hole or many holes spread uniformly or non-uniformly.

Reference is made to FIG. 8, which illustrates a top view of an upper cap of the acoustic head structure of the preferred embodiment of the present invention. An imaginary horizontal line 310 and an imaginary vertical line 320 divide the acoustic head 300 into four equal parts. The two acoustic holes 330 are not only set in the flank of the acoustic head 300 but symmetrically arranged on the horizontal 310.

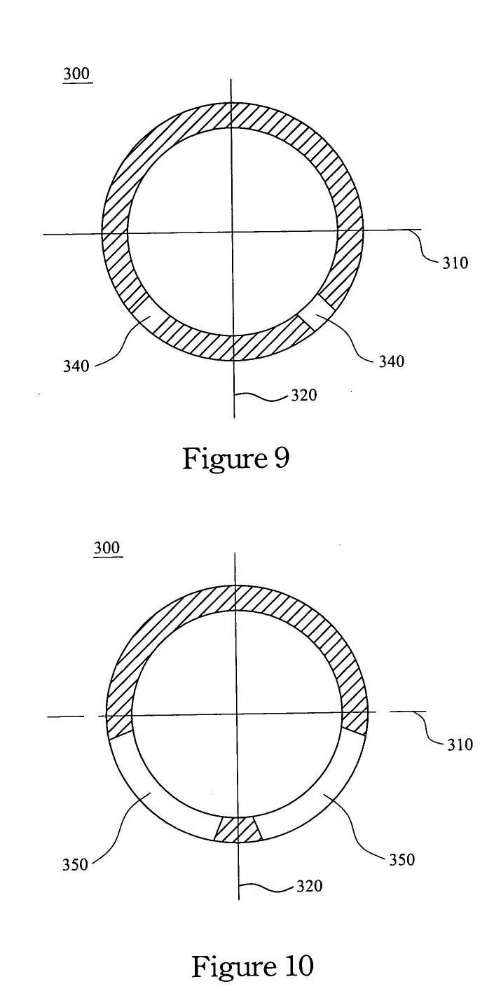

Comparison is made to FIG. 9, which shows the two acoustic holes 340 located not only below the horizontal line 310 but also symmetrically arranged about the vertical line 320. In order to accommodate the usage habits of singers and speakers, no matter how the microphone is used by hands or in the microphone holder, it is usually obliquely placed; thus, the arrangement of the acoustic holes conforms to this reality.

Comparison is also made to FIG. 10, which illustrates the two acoustic holes 350 as like the holes in FIG. 6 but as rectangular holes. This shape combined with the declination of the acoustic holes 235 provides an ideal acoustic head structure.

The acoustic holes 330, 340 and 350 in the acoustic head 300 in aforementioned FIGS. 8-10 can either be a single hole or several holes.

According to the composition and the embodiments above, there are many advantages of the present invention over the prior art, such as:

1. Compared with the prior art, the position of the acoustic holes is moved from the top to the flank of the upper cap so as to keep foreign matter from entering the acoustic head effectively and help to protect the electronics of the interior in the acoustic head from being damaged.

2. If the shape of the acoustic holes is in the form of a horn, there is more surface area so that sound collection is better, in addition to the benefit of preventing intrusion of foreign matter effectively.

3. If the shape of the acoustic holes is made in the form of a declined cylinder, the upper profile shelters from foreign matter but does not reduce sound collection. As a result, reliability is increased and replacement cost is reduced.

4. The acoustic holes are made in the form of rectangular holes in order to extend the area of sound collection, wherein sound collection is best when these holes are arranged on the same half of the upper cap. The holes are also effective in keeping foreign matter from entering the interior of the acoustic because of the downward inclining shape of the acoustic holes; so, the durability of the acoustic head of the microphone is raised.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An acoustic head structure of a microphone, comprising:
a substrate, including a circuit board;
a sound-processing unit, connected with the circuit board;
an upper lid, connected with the substrate; and
an acoustic hole, located in the flank of the upper lid.

2. The acoustic head structure of a microphone of claim 1, wherein the acoustic head structure is a rectangle.

3. The acoustic head structure of a microphone of claim 1, wherein the acoustic head structure is not a rectangle

4. The acoustic head structure of a microphone of claim 1, wherein the sound-processing unit comprises at least one sound sensor.

5. The acoustic head structure of a microphone of claim 1, wherein the sound-processing unit comprises at least one signal amplifier.

6. The acoustic head structure of a microphone of claim 1, wherein the acoustic hole is singular hole.

7. The acoustic head structure of a microphone of claim 1, wherein the acoustic hole is a plurality of holes.

8. The acoustic head structure of a microphone of claim 1, wherein the acoustic holes are in the form of a horn.

9. The acoustic head structure of a microphone of claim 1, wherein the acoustic holes are in the form of semi-conical horns.

10. The acoustic head structure of a microphone of claim 1, wherein the acoustic holes are in the form of a declining horn.

11. The acoustic head structure of a microphone of claim 1, wherein the acoustic holes are rectangular.

12. The acoustic head structure of a microphone of claim 1, wherein is the acoustic holes are located to one side of the microphone.

13. The acoustic head structure of a microphone of claim 1, wherein the acoustic holes are located opposite to each other about the microphone.
